(19) United States
(12) Patent Application Publication
(10) Pub. No.: US 2008/0105125 A1
(43) Pub. Date: May 8, 2008

(54) METHOD AND DEVICE FOR DISPOSING OF AIR COMPRESSION SYSTEM EFFLUENT

(76) Inventors: Robert G. Lauson, Porter, IN (US); Robert Scott Downing, Belvidere, IL (US)

Correspondence Address: CARLSON, GASKEY & OLDS, P.C., 400 WEST MAPLE ROAD, SUITE 350, BIRMINGHAM, MI, 48009, US

(21) Appl. No.: 11/557,150

(22) Filed: Nov. 7, 2006

(51) Int. Cl. B01D 53/00

(52) U.S. Cl. 95/288

(57) ABSTRACT

The method of effluent disposal thermal energy from an engine to vaporize the effluent. The engine drives an air compressor, which produces compressed air and an effluent byproduct. Both the thermal energy from the engine and the effluent from the air compressor communicate with a heat exchanger. After reaching an appropriate temperature, the heat exchanger transfer thermal energy to the effluent thereby vaporizing at least a portion of the effluent.

### BACKGROUND OF THE INVENTION

The application relates to air compression systems, and more particularly to disposing of air compression system effluent.

A typical air compression system includes an engine and a rotor assembly. The engine drives the rotor assembly to produce compressed air. Various industries rely on these types of air compression systems to generate supplies of compressed air for an array of applications, such as driving air tools, sand-blasting, painting, etc. Cooling the air after the compression process is often desirable but results in condensation that must be removed from the system. Additionally, upon delivery, expanding the compressed air produces the force necessary for the particular industrial application. Expansion lowers the temperature of the compressed air and, if lowered below the dew point of the compressed air stream, results in condensation of moisture in the compressed air stream. Air tools and other industrial applications generally require dry compressed air for optimum performance.

To cool compressed air many compression systems employ an aftercooler and separator. The aftercooler lowers the temperature of the compressed air below the dew point resulting in saturated compressed air and condensation before the compressed air is expanded. To dry the compressed air prior to expansion and lessen the associated risk of corrosion and water contamination, many air compression systems employ a dryer which removes additional moisture. The condensate primarily includes water, but may include other effluents, such as oil. The separator collects the effluent for disposal. The dryer may evaporate portions of the effluent.

To dispose of the collected effluent, some air compression systems may inject the effluent directly into the exhaust system of the engine driving the rotors. Such an approach exposes the exhaust system to the effluent, which may result in corrosion of the exhaust system. Some exhaust systems incorporate corrosion resistant materials, however this approach substantially increases the overall cost of the exhaust system. Further, because the exhaust system is not isolated from the engine, condensate may drain into other portions of the engine and eventually corrode them. Lastly, the exhaust system may not reach an adequate temperature for entirely vaporizing the effluent if injected too far downstream of the exhaust manifold. As a result, effluent may remain inside the exhaust system, which may later drain out and contaminate the environment.

It would be desirable to dispose of the effluent with minimal potential for corrosion of the exhaust system and with minimal impact on the environment.

### SUMMARY OF THE INVENTION

The method of effluent disposal according to the present invention utilizes thermal energy from an engine to vaporize the effluent. The engine drives an air compressor, which produces compressed air and an effluent byproduct. Both the thermal energy from the engine and the effluent from the air compressor communicate with a heat exchanger.

Communicating thermal energy to the heat exchanger raises the temperature of the heat exchanger. The heat exchanger communicates thermal energy to the effluent, thereby vaporizing at least a portion of the effluent. Once vaporized, the vapor releases into the atmosphere. In addition to vaporizing portions of the effluent, heating the effluent may combust portions of the effluent depending on the content of the effluent.

The heat exchanger, in this example a metal foam heat exchanger, secures directly to the engine. A spray tube introduces effluent from the compressed air to the thermal energy in the heat exchanger. In so doing, thermal energy from the engine exhaust pipe communicates to the effluent in the spray tube via the metal foam heat exchanger, whereupon the effluent in the spray tube vaporizes and/or combusts. A vent enables the resultant gas to escape into the atmosphere.

Accordingly, the present invention disposes of the effluent with minimal potential for corrosion and enhances the effectiveness of effluent vaporization.

These and other features of the present invention can be best understood from the following specification and drawings, the following of which is a brief description.

### BRIEF DESCRIPTION OF THE DRAWINGS

FIG. 1 schematically illustrates an example method of air compression system effluent disposal.

FIG. 2 is a detailed view of the example method.

FIG. 3 is a front view of an example heat exchanger mounted to an exhaust pipe.

FIG. 4 is a side view of an example heat exchanger mounted to an exhaust pipe.

FIG. 5 is a perspective view of a vent.

### DETAILED DESCRIPTION OF THE PREFERRED EMBODIMENT

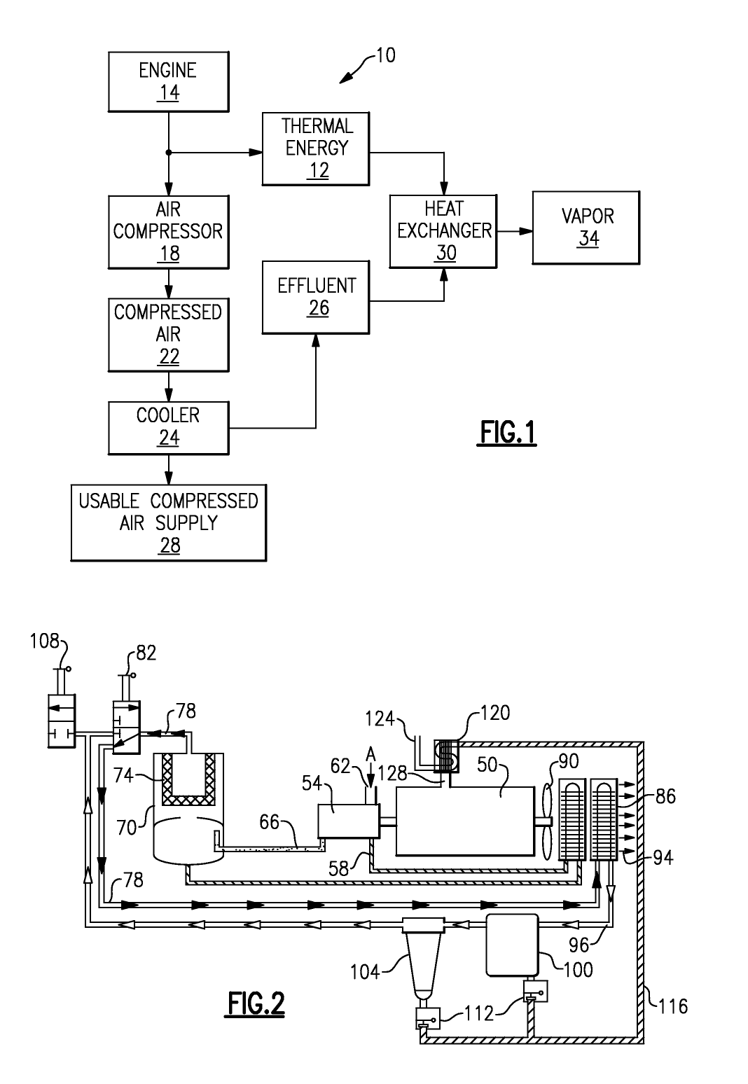

As shown in the schematic of FIG. 1, a method of effluent disposal 10 utilizes thermal energy 12 generated by an engine 14. The engine 14 drives an air compressor 18, which produces compressed air 22. A cooler 24 removes an effluent 26 byproduct from the compressed air 22 and provides a usable compressed air supply 28. Both the thermal energy 12 from the engine 14 and the effluent 26 from the cooler 18 are in communication with a heat exchanger 30.

Communicating thermal energy 12 to the heat exchanger 30 raises the temperature of the heat exchanger 30. After reaching an appropriate temperature, the heat exchanger 30 vaporizes portions of the effluent 26 upon contact. Once vaporized, the heat exchanger 30 releases vapor 34 into the atmosphere. In addition to vaporizing portions of the effluent 26, heating the effluent 26 may combust portions of the effluent 26, such as oil portions. Thus, the heat exchanger 30 vaporizes and/or combusts the effluent 26, depending on the specific content of the effluent 26.

Many types of engines for supplying the thermal energy 12 to the heat exchanger 30 may be utilized in conjunction with many varieties of air compressors. Referring to the detailed view of FIG. 2, a diesel engine 50 drives an oil flooded rotary air screw compressor 54. Ambient air A enters the air screw compressor 54 at an air inlet 62 and mixes with oil 58 to generate a compressed air/oil mixture 66. The air/oil mixture 66 enters an air receiver apparatus 70, which separates the oil 58 from the compressed air/oil mixture 66. The air receiver apparatus 70 also includes a separator element 74 for further filtering of the oil 58 from the compressed air/oil mixture 66.

After removing the oil 58 from the compressed air/oil mixture 66, the air receiver apparatus 70 communicates the compressed air 78 away from the air receiver apparatus 70. A bidirectional valve 82 allows a compressed air user to directly use the compressed air 78 via an outlet in the valve, or to route the compressed air 78 to an aftercooler 86. Utilizing a fan 90 driven by the diesel engine 50, the aftercooler 86 cools the compressed air 78. The fan 90 generates a cooling airflow 94 by moving ambient air A over the aftercooler 86. The aftercooler 86 cools the compressed air 78 to within 20 degrees F. or less of the air temperature of the cooling airflow 94 moving over the aftercooler 86.

Cooling the compressed air 78 may cause moisture in the compressed air 78 to condense. Although the compressed air 78 cycles through the air receiver apparatus 70, residual oil 58 may remain. As a result, cooled compressed air 96 exiting the aftercooler 86 communicates to a water separator 100 and a filter 104 for further drying and cleaning. Aftercooled, filtered, and dried air may then be obtained from service valve 108. A person skilled in the art and having the benefit of this disclosure may be able to develop other suitable methods of removing water, oil 58, and other contaminants from compressed air 78, as well as other suitable methods for cooling compressed air 78.

Reservoirs 112 beneath the water separator 100 and filter 104 preferably collect effluent 116, which is then communicated to a heat exchanger 120. In this example, the heat exchanger 120 is a finned heat exchanger. Thermal energy from the diesel engine 50 communicates to the heat exchanger 120 at a conduit connection 128. The thermal energy from the diesel engine 50 is ordinarily sufficient to bring the heat exchanger 120 to a temperature appropriate for vaporizing the effluent 116. Alternatively or in addition thereto, the heat exchanger 120 utilizes a supplemental thermal energy source such as an external electrical power source to reach the appropriate temperature.

When effluent 116 communicates with the heat exchanger 120 containing adequate thermal energy, water portions of the effluent 116 vaporize. Because thermal energy from the heat exchanger 120 vaporizes the effluent 116, rather than the diesel engine 50, the effluent 116 does not enter the diesel engine 50. Accordingly, the effluent will not corrode the exhaust system of the diesel engine 50, or other portions of the diesel engine 50. Effluent 120 ordinarily contains water and oil, but other liquids may be included. Whether the effluent 120 vaporizes or combusts depends on the effluents reaction to thermal energy. For example, if the effluent 116 contains oil 58, the oil 58 may combust when communicated to the heat exchanger 120. A vent 124 allows vapor to escape into the atmosphere.

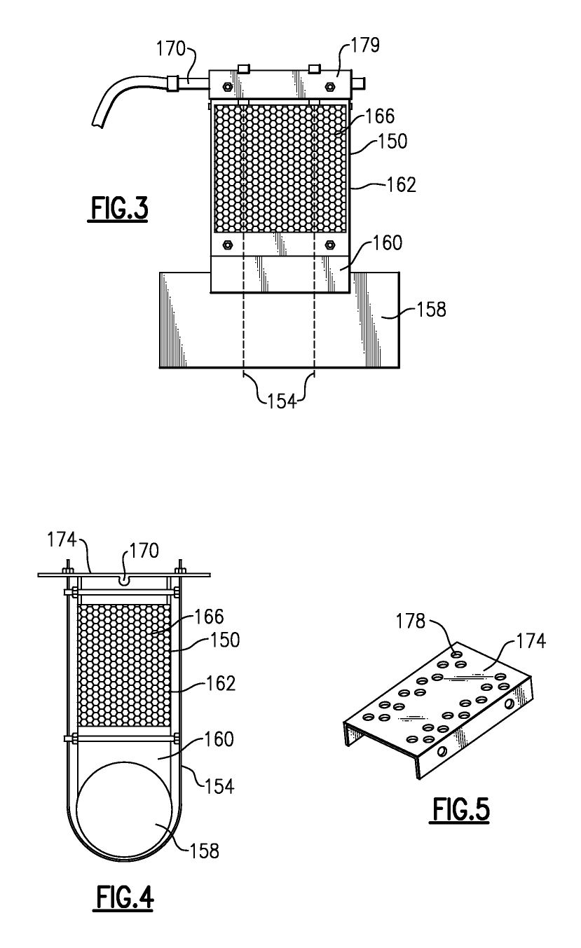

Referring to FIG. 3 a metal foam heat exchanger 150 is directly secured via C-bolt clamps 154 (also seen in FIG. 4) to an engine exhaust pipe 158. A spreader 160 ensures a direct connection between the heat exhaust pipe 158 and the metal foam heat exchanger 150. Although the metal foam heat exchanger 120 is directly connected to the engine exhaust pipe 158 in the illustrated embodiment, other areas may be likewise suitable for mounting the metal foam heat exchanger 150. For example only, the metal foam heat exchanger 150 may clamp directly to an engine block. Further, the metal foam heat exchanger 150 may indirectly mount to said engine exhaust pipe 158. In such an example, the metal foam heat exchanger 150 does not physically contact the engine exhaust pipe 158; instead, the metal foam heat exchanger 150 maintains thermal communication with said engine exhaust pipe 158.

The metal foam heat exchanger 150 preferably includes a sheet metal shell 162 housing a porous core material, here a metal foam core 166. A spray tube 170, such as a piccolo spray tube, communicates effluent to the metal foam heat exchanger 150. The spray tube 170 may be any pipe or tube that includes multiple holes for spraying. Thermal energy from the engine exhaust pipe 158 communicates with the effluent in the spray tube 170 via the metal foam heat exchanger 150, whereupon the effluent in the spray tube 170 vaporizes and/or combusts. The metal foam heat exchanger 150 relies on thermal energy from the engine exhaust pipe 158. However, the thermal energy source may be supplemented with other thermal energy sources. For instance, thermal energy from a source other than the engine exhaust pipe 158 may be used as a supplemental source of thermal energy. A vent 174 enables the resultant gas to escape into the atmosphere via escape structures 178 as shown in FIG. 6.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1) A method of disposing of an air compression system effluent comprising:
a) communicating thermal energy generated while compressing air to a heat exchanger;
b) removing effluent from the compressed air of said step (a); and
c) communicating the effluent to the heat exchanger.

2) The method as recited in claim 1, including the step of
d) at least partially vaporizing the effluent with the thermal energy.

3) The method as recited in claim 1, including the step of:
e) at least partially combusting the effluent with the thermal energy.

4) The method as recited in claim 1, wherein the heat exchanger is engine mounted.

5) The method as recited in claim 1, wherein the heat exchanger is mounted remote from an engine.

6) The method as recited in claim 5, wherein the heat exchanger is mounted to an exhaust of the engine.

7) A system for disposing of an air compression system effluent comprising:
a heat exchanger in thermal communication with an engine to receive an effluent from said air compression system to at least partially vaporize said effluent.

8) The system as recited in claim 7, wherein said heat exchanger clamps to said engine.

9) The system as recited in claim 7, wherein said heat exchanger includes a mounting bracket having a substantially C-shaped profile to engage a segment of an engine exhaust system remote from said engine.

10) The system as recited in claim 7, wherein said heat exchanger includes a porous media.

11) The system as recited in claim 10, wherein said porous media is metal foam.

12) The system as recited in claim 7, wherein said heat exchanger is mounted directly to an exhaust system component of said engine.

13) An air compression system comprising:
a compressor;
an engine which drives said compressor to produce compressed air; and
a heat exchanger in thermal communication with said engine, said heat exchanger in communication with an effluent from said compressed air to at least partially vaporize said effluent.

14) The air compression system as recited in claim 13, wherein said heat exchanger is mounted to said engine.

15) The air compression system as recited in claim 13, wherein said heat exchanger is remote from said engine.

16) The air compression system as recited in claim 13, wherein said engine is a diesel engine.

17) The air compression system as recited in claim 13, including a turbocharger.

18) The air compression system as recited in claim 15, wherein at least a portion of said heat exchanger is disposed between said turbocharger and said engine.
